(19) United States
(12) Patent Application Publication
(10) Pub. No.: US 2018/0180112 A1
(43) Pub. Date: Jun. 28, 2018

(54) FRICTION SURFACE

(71) Applicant: Schaeffler Technologies AG & Co. KG, Herzogenaurach (DE)

(72) Inventors: Anthony Jonnette, Drusenheim (FR); Tobias Bär, Achern (DE)

(73) Assignee: Schaeffler Technologies AG & Co. KG, Herzogenaurach (DE)

(21) Appl. No.: 15/580,020

(22) PCT Filed: May 3, 2016
(86) PCT No.: PCT/DE2016/200203

§ 371 Date: Dec. 6, 2017

(30) Foreign Application Priority Data
Jun. 11, 2015 (DE) 10 2015 210 731.0

(51) Int. Cl. F16D 13/72; F16D 13/64; F16D 69/00; F16D 65/84

(52) U.S. Cl. CPC F16D 13/72; F16D 13/64; F16D 2065/789; F16D 65/84; F16D 2069/004; F16D 69/00

(57) ABSTRACT

A friction surface includes at least one groove for dissipating a tempering medium, in that the groove has a stepped profile to constitute a fluidic resistance for the tempering medium. The tempering medium may be a cooling medium such as cooling oil. The stepped profile is, for example, achieved by stair-like delimitation lines of the groove. The stepped profile slows down a fluid flow of the tempering medium, in particular a cooling fluid, in particular through a plate pack of a multiplate clutch. In other words, the tempering medium or cooling fluid or cooling oil is braked. The slowed tempering medium can absorb heat over a longer period, in order to dissipate this heat from the friction surface or from the friction surface and a counter-surface in a plate pack. In this way, the cooling capacity can be improved.

### CROSS-REFERENCE TO RELATED APPLICATIONS

This application is the United States National Phase of PCT Appln. No. PCT/DE2016/200203 filed May 3, 2016, which claims priority to German Application No. DE102015210731.0 filed Jun. 11, 2015, the entire disclosures of which are incorporated by reference herein.

### TECHNICAL FIELD

The present disclosure concerns a friction surface with at least one groove for dissipating a tempering, or cooling, medium. The present disclosure furthermore concerns a friction lining of a clutch and/or brake device with at least one such friction surface. The present disclosure also concerns a friction plate with at least one such friction lining.

### BACKGROUND

German publication DE 196 26 688 A1 describes a friction lining for a clutch plate with a substantially annular carrier element and a friction lining layer of friction material applied thereon. The carrier element includes receiving regions or formed regions for fixing the friction lining, for example, to a spring segment or to a carrier or counter disc of a clutch plate. Openings are made in the carrier element, with or without erection of the edge regions of the openings in the radial area of the friction lining between the inner diameter and outer diameter. German publication DE 44 20 959 B4 discloses a hydrodynamic torque converter with a housing and a pump wheel, turbine wheel, guide wheel and bridging clutch with ring piston received in the housing; wherein a chamber which can be filled with oil is formed on both sides of the ring piston. The ring piston carries at least one friction surface which can be brought into frictional engagement with a counter-friction surface. The first of the chambers is formed within the friction surfaces between the ring piston and a component carrying the counter-friction surface. Channels are provided in the radial region of the friction surfaces in at least one component carrying or forming the friction surfaces, which channels allow, even on axial contact of the friction surfaces, an oil flow from the second of the chambers via the channels radially inward in the direction towards the rotation axis of the torque converter. At least one of the components carrying the friction surfaces has a friction lining. Grooves run in a zigzag or meander pattern in the friction lining in the circumferential direction and, viewed over their length, have a constant flow cross section.

Thus, there is a long-felt need to improve the tempering capacity of a clutch and/or brake device with a friction surface with at least one groove for dissipating a tempering medium.

### BRIEF SUMMARY

Example embodiments include a friction surface with at least one groove for dissipating a tempering medium, in that the groove has a stepped profile to constitute a fluidic resistance for the tempering medium. The tempering medium may be a cooling medium such as cooling oil. The stepped profile is, for example, achieved by stair-like delimitation lines of the groove. The stepped profile slows down a fluid flow of the tempering medium, in particular a cooling fluid, in particular through a plate pack of a multiplate clutch. In other words, the tempering medium or cooling fluid or cooling oil is braked. The slowed tempering medium can absorb heat over a longer period, in order to dissipate this heat from the friction surface or from the friction surface and a counter-surface in a plate pack. In this way, the cooling capacity can be improved. The groove is also known as a tempering medium groove or cooling oil groove. The groove may be provided in a friction plate of a multiplate clutch. The groove may in some cases also be provided in a steel plate of the multiplate clutch.

An exemplary embodiment of the friction surface includes the friction surface formed as an annular surface with an inner periphery, from which the groove with the stepped profile extends to an outer periphery of the annular surface. In operation of a clutch or brake equipped with a friction surface, the tempering medium can flow from the inner periphery of the friction surface through the groove with the stepped profile to the outer periphery of the annular surface.

A further exemplary embodiment of the friction surface includes several grooves with stepped profiles evenly distributed in the circumferential direction. This further improves the tempering capacity.

A further exemplary embodiment of the friction surface includes the groove with the stepped profile delimited by two stair-like groove delimitation lines. The stair-like groove delimitation lines could also be called stepped lines. The stepped lines delimit the groove laterally when viewed from the top. In depth, the groove is delimited by a groove base. The stair-like groove delimitation lines slow the tempering medium particularly effectively in operation of a clutch and/or brake device equipped with the friction surface.

A further exemplary embodiment of the friction surface includes the stair-like groove delimitation lines, relative to the friction surface, radially inwardly delimit an inlet of a tempering medium channel. The tempering medium channel runs between the groove base of the groove in the friction surface and a counter-surface which comes to rest on the friction surface.

A further exemplary embodiment of the friction surface includes the inlet of the tempering medium channel is delimited by two line portions running radially. The term “radial” refers to a rotation axis of the friction surface in operation of a clutch and/or brake device equipped with the friction surface.

A further exemplary embodiment of the friction surface includes a vertical line portion is cut away from each radially running line portion. The adjacent line portions are arranged alternately radially and vertically to the groove, in order to constitute the stair-like or stepped profile of the groove, up to the outer periphery of the annular surface.

A further exemplary embodiment of the friction surface includes the outlet of the tempering medium channel, relative to the friction surface, is arranged radially outwardly in the circumferential direction and offset to the inlet of the tempering medium channel, such that the inlet and the outlet of the tempering medium channel do not overlap in the circumferential direction. This further improves the cooling performance.

The present disclosure also concerns a friction lining of a clutch and/or brake device with at least one friction surface described above. The friction lining may in some cases also be supplied separately. The friction lining may be formed from a suitable friction lining material. This may be a wet-running friction lining material.

The present disclosure also concerns a friction plate with at least one friction lining described above. The friction plate preferably belongs to a plate pack, in particular of a multiplate clutch with such a plate pack, which comprises a plurality of friction plates that can be brought into engagement with counter-plates, in particular steel plates, in order to transmit a torque.

### BRIEF DESCRIPTION OF THE DRAWINGS

Further advantages, features and details of the present disclosure arise from the description below, in which various exemplary embodiments are described in detail with reference to the drawing. The drawing shows:

FIG. 1 a simplified depiction of a plate pack of a multiplate clutch in half section;

FIG. 2 a perspective depiction of a quarter section through a lining carrier of a friction plate of a multiplate clutch in FIG. 1, and

FIG. 3 a friction lining with a friction surface which has a groove with a stepped profile, for the lining carrier from FIG. 2.

### DETAILED DESCRIPTION

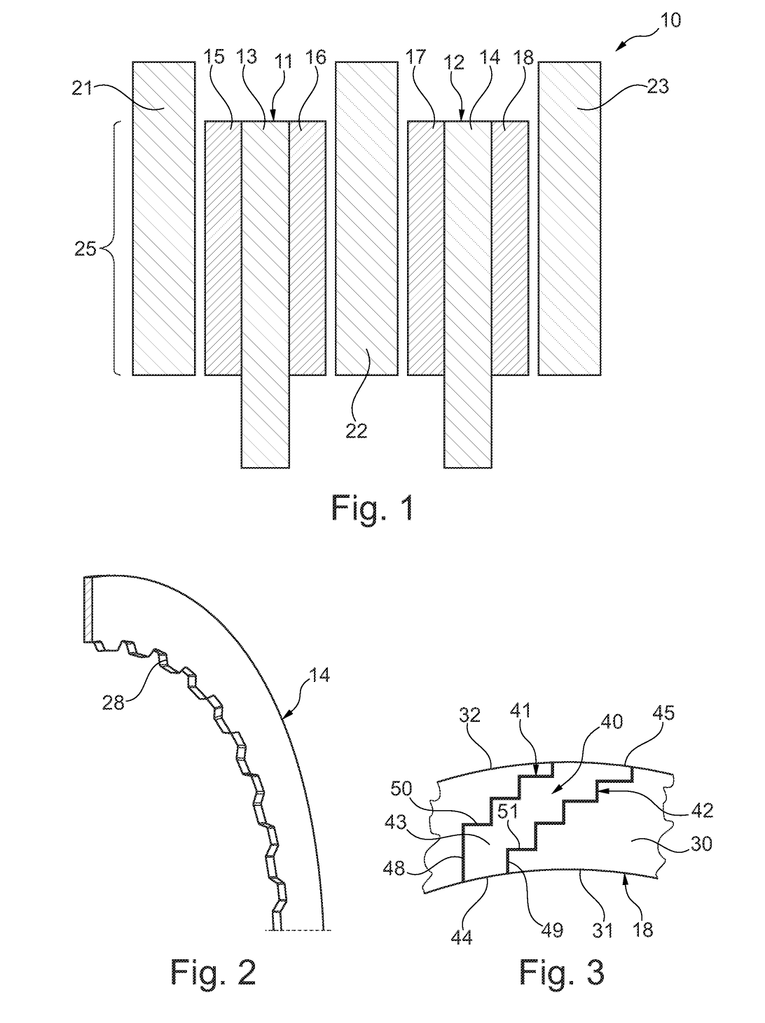

FIG. 1 shows a plate pack 10 with two inner plates 11, 12 and three outer plates 21, 22, 23 simplified in half section. The inner plates 11, 12 and the outer plates 21, 22, 23 have substantially the form of annular discs with rectangular ring cross sections, as shown in the half section view in FIG. 1.

The inner plates 11, 12 each comprise a lining carrier 13, 14, on each of which again two friction linings 15, 16; 17, 18 are attached. The lining carriers 13, 14 are made for example from steel material.

The friction linings 15 to 18 are preferably formed from a suitable friction lining material. In a contact region 25, the inner plates 11, 12 with their friction linings 15 to 18 can be brought into contact with the outer plates 21 to 23. To this end, the inner plate 11 with the lining carrier 13 and the friction linings 15, 16, is arranged between the outer plates 21 and 22 in an axial direction.

The term “axial” relates to a rotation axis of the plate pack 10. The rotation axis in FIG. 1 runs in the horizontal direction. Axially means in the direction of or parallel to the rotation axis. Similarly, radially means transversely to the rotation axis. The inner plates 12 with the lining carrier 14 and friction linings 17, 18 are arranged between the two outer plates 22 and 23 in the axial direction.

FIG. 2 shows in perspective, in a quarter section, the lining carrier 14 for the two friction linings 17, 18 of the inner plate 12 from FIG. 1. The lining carrier 12 has substantially the form of an annular disc with a rectangular ring cross section.

The lining carrier 14 is equipped with inner toothing 28 for installation of the friction plate in a multiplate clutch. The inner toothing 28 serves to constitute a rotationally fixed connection between the friction plate and a plate carrier (not shown) of the multiplate clutch.

FIG. 3 shows an extract of the friction lining 18 in top view. The friction lining 18 comprises a friction surface 30. The friction surface 30 is configured as an annular surface with an inner periphery 31 and an outer periphery 32.

A groove 40 with a stepped profile extends in the manner of a stair from the inner periphery 31 to the outer periphery 32 of the friction surface 30. The groove 40 is delimited by two stair-like groove delimitation lines 41, 42, which are also called stepped lines.

A tempering medium channel 43 is delimited vertically to the plane of the paper by a groove base and a counter-surface of a counter-plate, not shown in FIG. 3. The counter-plate is for example the outer plate 23 shown in FIG. 1.

The tempering medium channel 43 comprises an inlet 44 on the inner periphery 31 of the friction surface 30. On the outer periphery 32 of the friction surface 30, the tempering medium channel 43 has an outlet 45.

The inlet 44 for the tempering medium is delimited by two line portions 48 and 49 running radially. A line portion 50 is cut away vertically from the radially running line portion 48 of the groove delimitation line 41. Parallel to this, a line portion 51 is cut away vertically from the radially running line portion 49 of the groove delimitation line 42.

The resulting stair form of the groove delimitation lines 41, 42, because of its horizontal portions which are formed by the line portion 50, 51, slows down the tempering medium, in particular the cooling oil, which, by the rotation in operation of the clutch device and the resulting centrifugal forces, is conducted from the inlet 44 radially outward to the outlet 45 of the tempering medium channel 43. The heat absorption of the tempering medium, in particular the cooling oil, can be controlled in a particularly advantageous fashion by suitable variation of the horizontal portions.

### LIST OF REFERENCE SIGNS

10 Plate pack
11 Inner plate
12 Inner plate
13 Lining carrier
14 Lining carrier
15 Friction lining
16 Friction lining
17 Friction lining
18 Friction lining
21 Outer plate
22 Outer plate
23 Outer plate
25 Contact region
28 Inner toothing
30 Friction surface
31 Inner periphery
32 Outer periphery
40 Groove
41 Groove delimitation line
42 Groove delimitation line
43 Tempering medium channel
44 Inlet
45 Outlet
48 Line portion
49 Line portion
50 Line portion
51 Line portion

1.-10. (canceled)

11. A friction surface with at least one groove for dissipating a tempering medium, wherein the groove has a stepped profile to constitute a fluidic resistance for the tempering medium.

12. The friction surface as claimed in claim 11, wherein the friction surface is formed as an annular surface with an inner periphery from which the groove with the stepped profile extends to the outer periphery of the annular surface.

13. The friction surface as claimed in claim 12, wherein several grooves with stepped profiles are evenly distributed in a circumferential direction.

14. The friction surface as claimed in claim 12, wherein the groove with the stepped profile is delimited by two stair-like groove delimitation lines.

15. A friction lining of a clutch or brake device with at least one friction surface as claimed in claim 12.

16. A friction plate with at least one friction lining as claimed in claim 15.

17. The friction surface as claimed in claim 11, wherein several grooves with stepped profiles are evenly distributed in a circumferential direction.

18. The friction surface as claimed in claim 17, wherein the several grooves with stepped profiles are each delimited by two stair-like groove delimitation lines.

19. A friction lining of a clutch or brake device with at least one friction surface as claimed in claim 18.

20. A friction plate with at least one friction lining as claimed in claim 19.

21. The friction surface as claimed in claim 11, wherein the groove with the stepped profile is delimited by two stair-like groove delimitation lines.

22. The friction surface as claimed in claim 21, wherein the stair-like groove delimitation lines, relative to the friction surface, delimit a radial inward inlet of a tempering medium channel.

23. The friction surface as claimed in claim 22, wherein the inlet of the tempering medium channel is delimited by two radial line portions.

24. The friction surface as claimed in claim 23, wherein a vertical line portion is cut away from each radial line portion.

25. The friction surface as claimed in claim 24, wherein an outlet of the tempering medium channel, relative to the friction surface, is arranged radially outwardly in the circumferential direction and offset to the inlet of the tempering medium channel, such that the inlet and the outlet of the tempering medium channel do not overlap in the circumferential direction.

26. A friction lining of a clutch or brake device with at least one friction surface as claimed in claim 25.

27. The friction surface as claimed in claim 23, wherein an outlet of the tempering medium channel, relative to the friction surface, is arranged radially outwardly in the circumferential direction and offset to the inlet of the tempering medium channel, such that the inlet and the outlet of the tempering medium channel do not overlap in the circumferential direction.

28. A friction lining of a clutch or brake device with at least one friction surface as claimed in claim 27.

29. A friction plate with at least one friction lining as claimed in claim 28.
